(19) United States
(12) Patent Application Publication
(10) Pub. No.: US 2003/0221380 A1
(43) Pub. Date: Dec. 4, 2003

(54) Insulating and protective window shutter

(76) Inventors: Lovick Thomas Kreps, Atlanta, GA (US); Kenneth Lee McClintock, Dallas, TX (US)

Correspondence Address: Bryan W. Bockhop, Esq., ARNALL GOLDEN GREGORY LLP, 2800 One Atlantic Center, 1201 West Peachtree Street, Atlanta, GA, 30309-3450, US

(21) Appl. No.: 10/454,086

(22) Filed: Jun. 4, 2003

Related U.S. Application Data
(60) Provisional application No. 60/384,839, filed on Jun. 4, 2002.
(60) Provisional application No. 60/391,954, filed on Jun. 28, 2002.

(51) Int. Cl. E06B 3/26

(52) U.S. Cl. 52/202; 52/203

(57) ABSTRACT

A shutter for covering a window that includes a rigid member and a foam body. The foam body has a shutter form and is adjacent to at least one side of the rigid member. A hard impervious coating surrounds the foam body and the rigid member. A structure allows the shutter to move between a first position and a different second position. A lock selectively holds the shutter in the first position.

### CROSS REFERENCE TO A PROVISIONAL PATENT APPLICATION

The present patent application hereby claims priority on U.S. Provisional Patent application serial No. 60/384,839, filed on Jun. 4, 2002, and No. 60/391,954, filed on Jun. 28, 2002, both of which are hereby incorporated by reference in their entirety.

### BACKGROUND OF THE INVENTION

1. Field of the Invention

The present invention relates to architectural products and, more specifically, to a window-type shutter that provides insulation and protects from external damage.

2. Description of the Prior Art

Shutters have long been used to cover and decorate windows. Vacuum-formed plastic shutters are used for decoration, but they do not provide protection or insulation to windows. Conventional wood shutters provide limited insulation and protection for the windows to which they are applied. However, wood shutters are limited in their ability to protect windows against storm damage, such as damage occurring as a result of a hurricane. Wood shutters also require frequent painting and are subject to rot.

Fiberglass shutters do provide some protection. However, they provide limited insulation and are subject to degraded appearance over time when exposed to sunlight and weathering. Furthermore, fiberglass shutters are expensive and heavy.

Therefore, there is a need for a window-type shutter that provides insulation to a window. There is also a need for a shutter that protects from external damage. There is also a need for a shutter that requires little maintenance. There is also a need for a shutter that is relatively inexpensive and light.

### SUMMARY OF THE INVENTION

The disadvantages of the prior art are overcome by the present invention that, in one aspect is a shutter for covering a window that includes a rigid member and a foam body. The foam body has a shutter form and is adjacent to at least one side of the rigid member. A hard impervious coating surrounds the foam body and the rigid member. A structure allows the shutter to move between a first position and a different second position. A lock selectively holds the shutter in the first position.

In another aspect, the invention is a shutter that includes a corrugated aluminum plate. A foam body, having a shutter form, envelops the corrugated aluminum plate. An epoxy coating surrounds the foam body.

In yet another aspect, the invention is a method of making a shutter having a thickness, a height and a width. A rigid member is formed so as to have dimensions that are no greater than the thickness, the height and the width of the shutter. A foam body is molded to have a shape and size corresponding to the shutter and so that the foam body is disposed so as to be adjacent to at least one side of the rigid member. A hard and impervious coating is applied to the shutter so as to surround the rigid member and the foam body. A structure that allows the shutter to move between a first position and a different second position is attached to the shutter. A lock that selectively holds the shutter in the first position is affixed to the shutter.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a top front perspective view of one embodiment of the invention.

FIG. 1B is a cross-sectional view of the embodiment shown in FIG. 1A, taken along line 1B-1B

FIG. 1C is a cross-sectional view of the embodiment shown in FIG. 1B, taken along line 1C-1C

FIG. 2A is a top front perspective view of rigid member.

FIG. 2B is a cross-sectional view of the rigid member shown in FIG. 2A, taken along line 2B-2B.

FIG. 3A is a cross-sectional view of one embodiment of the invention.

FIG. 3B is a front perspective view of a rigid member according to the embodiment shown in FIG. 3A.

FIG. 4 is an elevational view of a hinging mechanism.

FIG. 5A is an elevational view of a pivoting mechanism.

FIG. 5B is a plan view of a pivot.

FIG. 6A is an elevational view of a track-mounted shutter position with the shutters in an open position.

FIG. 6B is an elevational view of a track-mounted shutter position with the shutters in a closed position.

FIG. 6C is a detail of track and track engagement structure used to position a shutter.

FIG. 7A is an elevational view of a locking mechanism in a locked position.

FIG. 7B is an elevational view of a locking mechanism in an unlocked position.

FIG. 8A is an elevational view of an alternative locking mechanism in a locked position.

FIG. 8B is an elevational view of an alternative locking mechanism in an unlocked position.

FIG. 9 is a cross-sectional view of an embodiment having a rigid member on a back side of a shutter.

FIG. 10 is a cross-sectional view of an embodiment having a tubular reinforcing member.

FIG. 11 is a schematic diagram showing a method of making a shutter.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

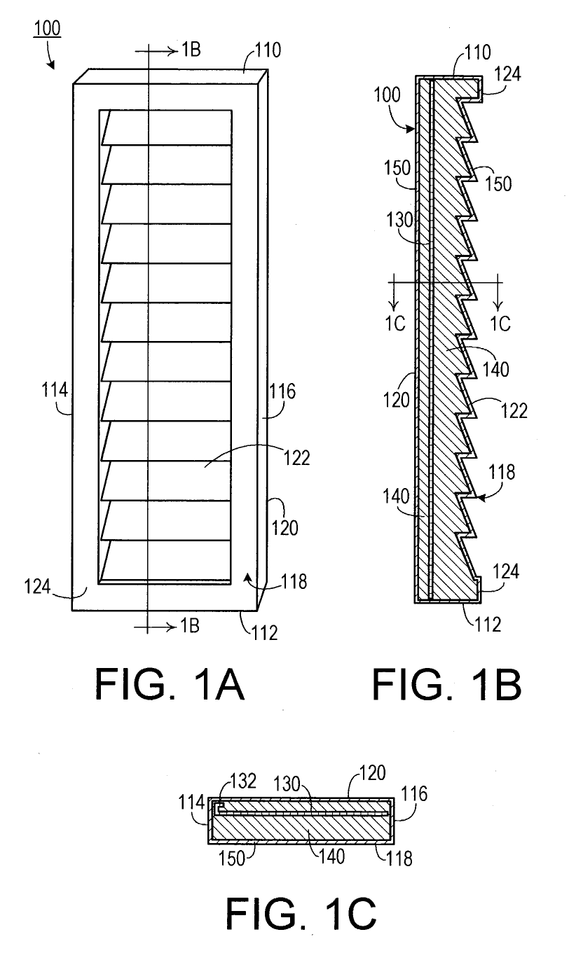

A shutter 100 is shown in FIG. 1A. The shutter 100 has a top end 110, an opposite bottom end 112, a first side 114, an opposite second side 116, a front side 118 and an opposite back side 120. The front side 118 may include a border region 124 and a plurality of louver shapes 122. The front side 118 may also include other shapes typically found on the surface of a shutter, such as raised-panel shapes.

As shown in FIG. 1B, the shutter 100 includes a rigid member 130 that is disposed along the length of the shutter 100. The rigid member 130 is a plate made of a rigid substance capable of protecting a window from storm damage, such as sheet aluminum or steel, a polymer (for example, sheet acrylic) or a composite material. Such composite materials could include polymer-based composites (for example, graphite-reinforced polymers, fiber glass-reinforced polymers and nano tube-reinforced polymers) and natural composite materials (for example, particleboard).

A foam body 140 covers at least one side of the rigid member 130, and in one embodiment completely envelops the rigid member 130. The foam body 140 is made of a foam that provides additional insulation to the window and that is capable of absorbing shock from objects striking the shutter 100. One example of a suitable type of foam is urethane foam. Another example is polystyrene foam.

The outer surface of the shutter 100 includes a hard and impervious coating 150. The coating 150 could be in the form of a polymer, such as epoxy. Epoxy provides resistance to denting resulting from light contact with the shutter 100. A paint could be used for the hard and impervious coating 150.

As shown in FIG. 1C, a mounting member 132 may be added to the shutter 100 to facilitate attachment of the shutter 100 to a wall. The mounting member 132 may be integrated with the rigid member 130 or it may be separate. A mounting member 132 is not necessary, as in some embodiments of the invention; a wall attachment may be made directly to the rigid member 130.

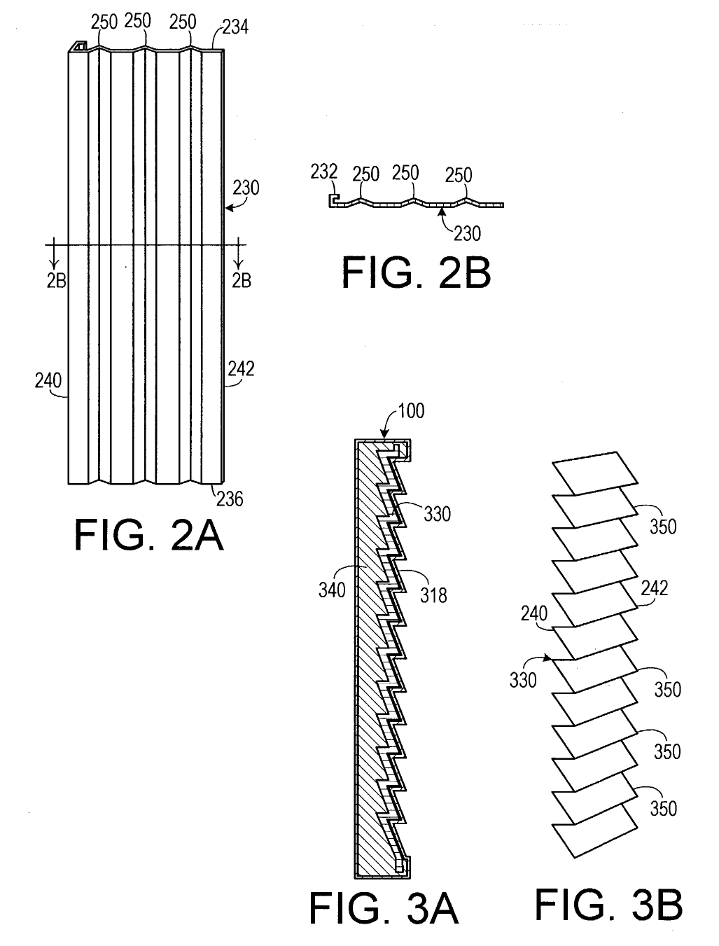

As shown in FIGS. 2A and 2B, the rigid member 230 includes a top edge 234, an opposite bottom edge 236, a first side edge 240 and an opposite second side edge 242. A plurality of corrugations 250 may extend longitudinally from the top edge 234 to the bottom edge 236 to provide extra strength to the rigid member 230.

As shown in FIGS. 3A and 3B, corrugations 350 may extend latitudinally from the first side edge 240 to the second side edge 242. If the latitudinal corrugations 330 are in the shape of louvers, or other desired outward form, the rigid member 330 could be disposed adjacent the front side 318 of the shutter 300.

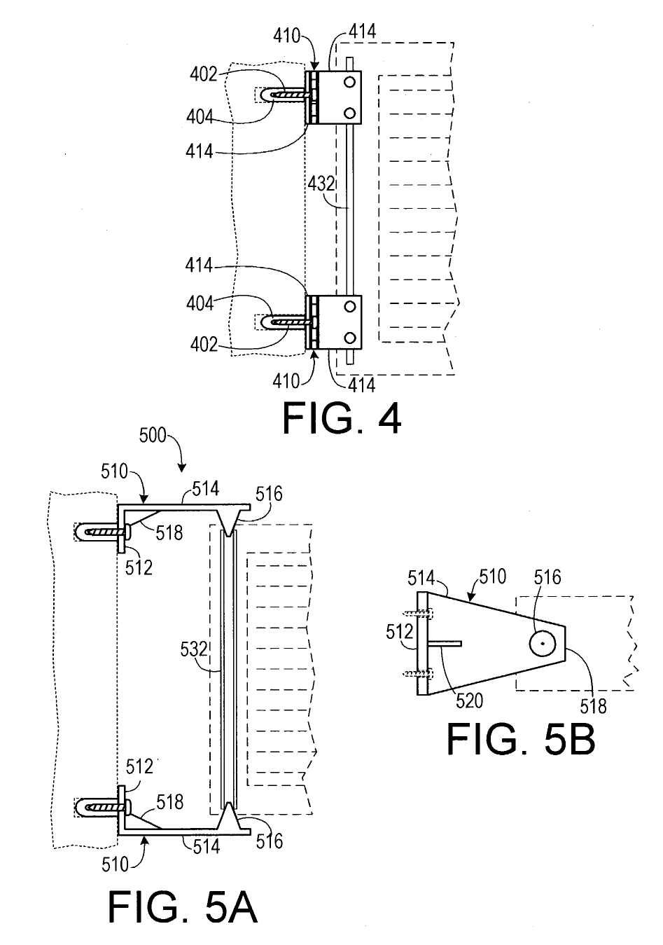

As shown in FIG. 4, a structure, such as a hinge 410 allows the shutter to move between a first position (such as covering a window) and a second position (such as when the shutter is opened and not covering the window). The hinge 410 includes two hinge plates 414, one of which may be attached to the mounting member 432 (or directly to the rigid member in some applications), the other of which is mounted to a wall. Mounting to a wall, such as a masonry wall, could be accomplished by driving anchors 404 into holes drilled into the wall and driving screws 402 into the anchors 404, thereby attaching one of the hinge plates 414 to the wall.

As shown in FIGS. 5A and 5B, the positioning structure 500 may include two pivot brackets 510 placed to hold the mounting member 532 there between. Each pivot bracket 510 includes an upright member 512 that may be attached to the wall. A cantilever 514 extends outwardly from the upright member 512 and a détente 516 extends transversely from a distal end 518 of the cantilever 514. A structural support 518 may also be applied between the upright member 512 and the cantilever 514. The détentes 516 are placed facing each other so as to engage the mounting member 532 and to allow the mounting member 532 (along with the shutter) to rotate about an axis between the détentes 516.

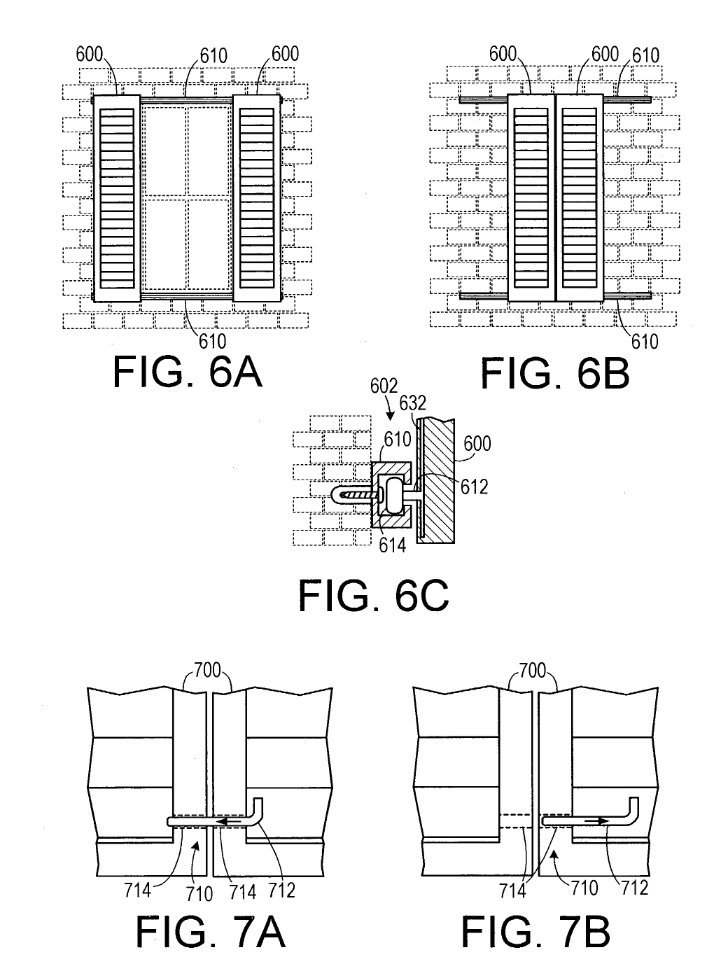

Another example of a positioning structure is shown in FIGS. 6A-6C. The structure includes a track 610 mounted adjacent to a window and a track engagement structure 602. The track engagement structure 602 includes an axle 612 and a wheel 614, mounted thereon, that runs along the track 610 and allows the shutter 600 to move between the first position and the second position along the track 610.

As shown in FIGS. 7A and 7B, a lock 710 selectively holds the shutter 700 in the closed position. The lock 710, in a simple form, includes a locking pin 712 that slides through a hole 714 in each of two shutters 700.

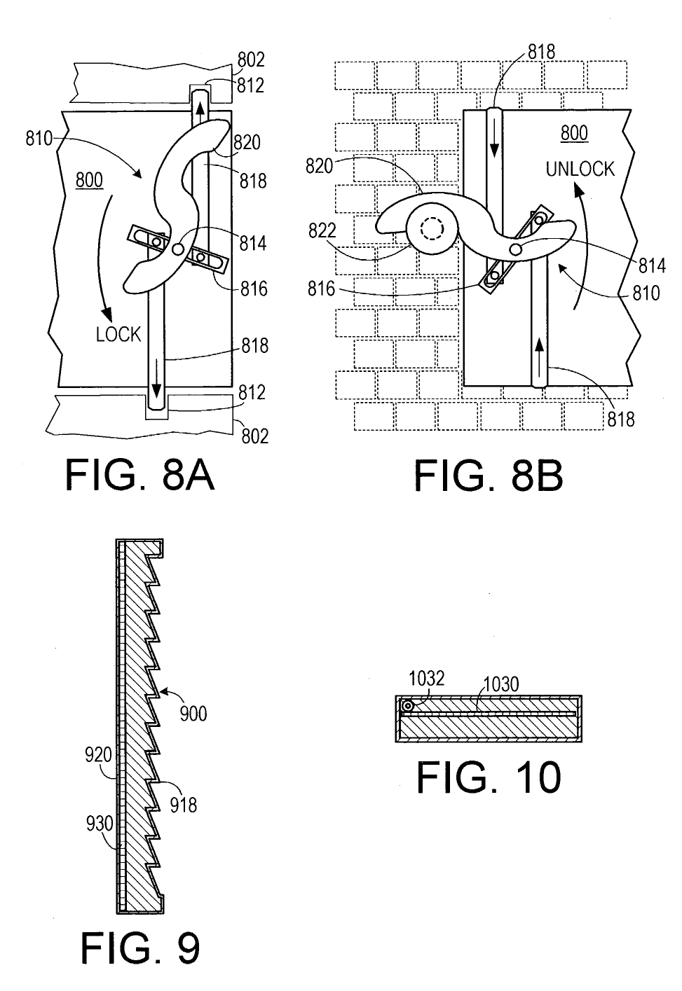

Another example of a lock 810 is shown in FIGS. 8A and 8B. This example includes a standard shutter dog 820 affixed to the shutter 800. The shutter dog 820 is affixed to a pivot pin 814, which is affixed to a locking lever 816. The locking lever 816 is engaged with two sliding pins 818 so as to cause the sliding pins 818 to extend or retract when the shutter dog 820 is turned. The sliding pins 818 slide into holes 812 drilled into the windowsill 802 so as to lock the shutter 800 in the closed position. The shutter 800 may be maintained in the open position by engaging the shutter dog 820 with a wall-mounted engagement knob 822.

As shown in FIG. 9, the rigid member 930 may be placed along the back side 920 of the shutter 900, opposite the louvered side 918. As shown in FIG. 10, the mounting member 1032 may be a tube, which is not formed as part of the rigid member 1030.

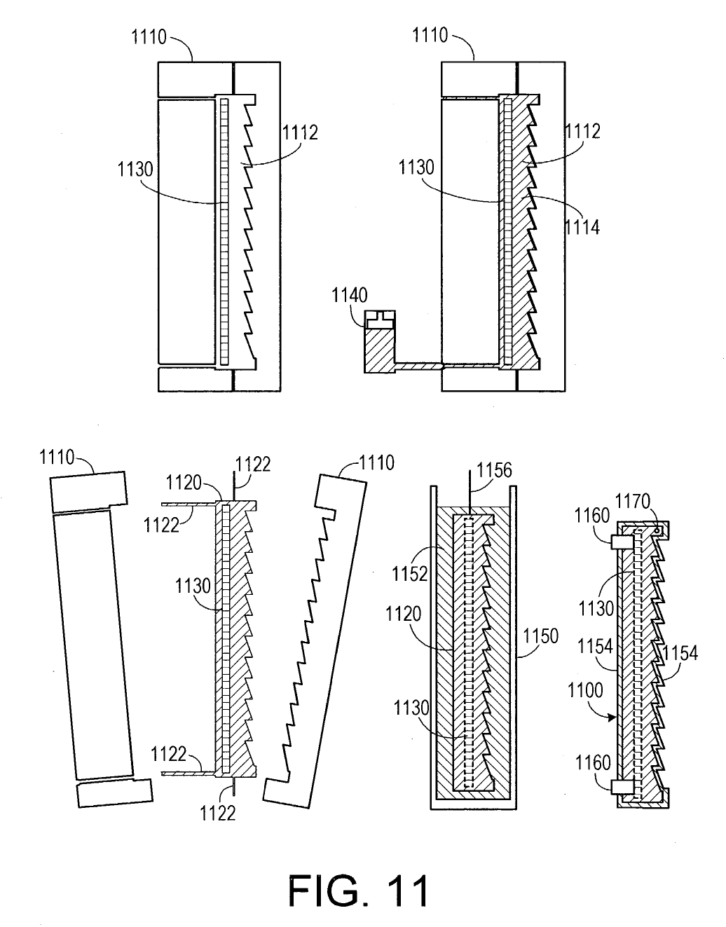

One example of a method for making a shutter according to the invention is demonstrated in FIG. 11. The rigid member 1130 is placed in a cavity 1112 in a mold 1110. The cavity has the general shape of the finished shutter 1100. Foam 1114 is injected into the cavity 1112 from an injector 1140 and allowed to harden. The mold 1110 is removed, leaving a shutter blank 1120. Any mold flashing and injection port extrusions 1122 are removed and the hard impervious coating 1154 is applied to the shutter blank 1120. This may be done by suspending the mold blank 1120 from a wire 1156 and dipping it into a vat 1150 of a liquid polymer 1152 (such as epoxy) from which the hard coating 1154 is made. This may also be done by spraying the liquid polymer onto the mold blank 1120. Once the coating 1154 has cured, any added parts (such as hinges 1160) may be attached. While injection molding is shown herein, other methods of forming the shutter may be employed. Examples include stamping the foam and milling the foam.

The above-described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A shutter for covering a window, comprising:
a. a rigid member;
b. a foam body having a shutter form, the foam body adjacent to at least one side of the rigid member;
c. a hard impervious coating, surrounding the foam body and the rigid member;
d. a structure that allows the shutter to move between a first position and a different second position; and
e. a lock that selectively holds the shutter in the first position.

2. The shutter of claim 1, further comprising a mounting member extending longitudinally adjacent a side edge of the shutter.

3. The shutter of claim 1, wherein the rigid member is surrounded by the foam body.

4. The shutter of claim 1, wherein the foam body has a front side and an opposite back side and wherein the rigid member is disposed adjacent to a selected one of the front side or the back side.

5. The shutter of claim 1, wherein the rigid member comprises a plate having a top edge, an opposite bottom edge, a first side edge and an opposite second side edge.

6. The shutter of claim 5, wherein the plate comprises a plurality of corrugations.

7. The shutter of claim 6, wherein each of the plurality of corrugations extends from a position adjacent the top edge to a position adjacent the bottom edge.

8. The shutter of claim 6, wherein each of the plurality of corrugations extends from a position adjacent the first side edge to a position adjacent the second side edge.

9. The shutter of claim 8, wherein the plurality of corrugations are formed in a shape that resembles louvers.

10. The shutter of claim 5, wherein the plate comprises aluminum.

11. The shutter of claim 5, wherein the plate comprises a composite material.

12. The shutter of claim 5, wherein the plate comprises a polymer.

13. The shutter of claim 1, wherein the foam body comprises urethane.

14. The shutter of claim 1 wherein the hard impervious coating comprises a polymer.

15. The shutter of claim 14, wherein the hard impervious coating comprises epoxy.

16. The shutter of claim 1, wherein the structure comprises a hinge having a first member that is attached to the shutter and a second member, hingedly attached to the first member, that is capable of being attached to a wall.

17. The shutter of claim 1, wherein the structure comprises:
a. a first pivot member including a upright member that is capable of being attached to a wall, a cantilever extending outwardly from the upright member and a first détente extending transversely from a distal end of the cantilever;
b. a second pivot member, spaced apart from the first pivot member, including a upright member that is capable of being attached to a wall, a cantilever extending outwardly from the upright member and a second détente extending transversely from a distal end of the cantilever; and
C. an engagement member, affixed to the shutter and in engagement with the first détente and the second détente.

18. The shutter of claim 1, wherein the structure comprises
a. a track mounted adjacent to a window; and
b. a track engagement structure that is affixed to the shutter and engaged with the track so as to allow the shutter to move between the first position and the second position along the track.

19. A shutter comprising:
a. a corrugated aluminum plate;
b. a foam body having a shutter form and enveloping the corrugated aluminum plate;
c. an epoxy coating surrounding the foam body;
d. a structure that allows the shutter to move between a first position and a different second position; and
e. a lock that selectively holds the shutter in the first position.

20. A method of making a shutter, having a thickness, a height and a width, comprising the steps of:
a. forming a rigid member so as to have dimensions that are no greater than the thickness, the height and the width of the shutter;
b. molding a foam body to have a shape and size corresponding to the shutter and disposing the foam body so as to be adjacent to at least one side of the rigid member;
c. applying a hard and impervious coating to the shutter so as to surround the rigid member and the foam body;
d. attaching a structure that allows the shutter to move between a first position and a different second position to the shutter; and
e. affixing to the shutter a lock that selectively holds the shutter in the first position.

21. The method of claim 20, wherein the molding step comprises injection molding.
